(19) United States
(12) Patent Application Publication
(10) Pub. No.: US 2020/0302003 A1
(43) Pub. Date: Sep. 24, 2020

(54) Capture of Recently-Arrived Text Chunk of Real-Time Post-Appending Body of On-Screen Text

(71) Applicant: Forcepoint, LLC, Austin, TX (US)

(72) Inventor: Robert Kerr, Orem, UT (US)

(21) Appl. No.: 16/359,338

(22) Filed: Mar. 20, 2019

(51) Int. Cl. G06F 17/22; G06F 17/24; G10L 13/04; G06F 21/57

(52) U.S. Cl. CPC G06F 17/2258; G06F 17/2217; G06F 21/57; G10L 13/043; G06F 17/243

(57) ABSTRACT

Described herein is a technology that facilitates capture of recently-arrived text chunk of real-time post-appending body of on-screen text as disclosed. Exemplary implementations may: monitor a real-time post-appending body of on-screen text; obtain an end endpoint of the monitored body, which indicates a locus of the final character of existing on-screen text of the monitored body; remember the locus of the final character of existing on-screen text; adjust the end endpoint to an interior locus in the existing on-screen text of the monitored body; obtain a trigger that indicates that the monitored body may have been post-appended with new on-screen text; and in response to the trigger, chunk new on-screen text of the post-appended body based on a difference between the remembered locus and a new endpoint of the new on-screen text of the post-appended body.

### BACKGROUND

An insider threat is a malicious threat to an organization that comes from people within the organization, such as employees, former employees, contractors, vendors, or business associates. As the name implies, insiders have inside information concerning the organization's security practices, data and computer systems.

The insider threat may involve fraud, the theft of confidential or commercially valuable information, the theft of intellectual property, or the sabotage of computer systems. Because of their physical proximity to an organization's data, the insider does not need to hack into the organizational network through the outer perimeter by traversing firewalls. Rather, the insider is already inside the buildings and often have direct access to the organization's internal network. Insider threats are harder to defend against than attacks from outsiders since the insider already has legitimate access to the organization's information and assets.

Insider threat management is the process and practice of preventing, combating, detecting, and monitoring insiders in order to fortify an organization's data from theft, fraud and damage.

### SUMMARY

One aspect of the present disclosure relates to a system configured to facilitate capture of recently-arrived text chunk of real-time post-appending body of on-screen text. The system may include one or more hardware processors configured by machine-readable instructions. The processor(s) may be configured to monitor a real-time post-appending body of on-screen text, the on-screen text being produced by an application executing on a computing system. The processor(s) may be configured to obtain an end endpoint of the monitored body, which indicates a locus of the final character of the existing on-screen text of the monitored body. The processor(s) may be configured to remember the locus of the final character of existing on-screen text. The processor(s) may be configured to adjust the end endpoint to an interior locus in the existing on-screen text of the monitored body. The processor(s) may be configured to obtain a trigger that indicates that the monitored body may have been post-appended with new on-screen text. The processor(s) may be configured to, in response to the trigger, chunk new on-screen text of the post-appended body based on a difference between the remembered locus and a new endpoint of the new on-screen text of the post-appended body. [000$] Another aspect of the present disclosure relates to a method that facilitates capture of recently-arrived text chunk of real-time post-appending body of on-screen text. The method may include monitoring a real-time post-appending body of on-screen text, the on-screen text being produced by an application executing on a computing system. The method may include obtaining an end endpoint of the monitored body, which indicates a locus of the final character of the existing on-screen text of the monitored body. The method may include remembering the locus of the final character of the existing on-screen text. The method may include adjusting the end endpoint to an interior locus in the existing on-screen text of the monitored body. The method may include obtaining a trigger that indicates that the monitored body may have been post-appended with new on-screen text. The method may include, in response to the trigger, chunking new on-screen text of the post-appended body based on a difference between the remembered locus and a new endpoint of the new on-screen text of the post-appended body.

Yet another aspect of the present disclosure relates to a non-transient computer-readable storage medium having instructions embodied thereon, the instructions being executable by one or more processors to perform a method that facilitates capture of recently-arrived text chunk of the real-time post-appending body of on-screen text. The method may include monitoring a real-time post-appending body of on-screen text, the on-screen text being produced by an application executing on a computing system. The method may include obtaining an end endpoint of the monitored body, which indicates a locus of the final character of the existing on-screen text of the monitored body. The method may include remembering the locus of the final character of the existing on-screen text. The method may include adjusting the end endpoint to an interior locus in the existing on-screen text of the monitored body. The method may include obtaining a trigger that indicates that the monitored body may have been post-appended with new on-screen text. The method may include, in response to the trigger, chunking new on-screen text of the post-appended body based on a difference between the remembered locus and a new endpoint of the new on-screen text of the post-appended body.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates an example system configured to facilitate capture of recently-arrived text chunk of real-time post-appending body of on-screen text, in accordance with the technology described herein.

FIGS. 2A and 2B illustrate a portion of the relevant operation of an example application that the technology described herein operates thereupon.

FIGS. 3A, 3B, and 3C illustrate a portion of the relevant operation, in accordance with the technology described herein, of the technology described herein in association with an example application that the technology described herein operates thereupon,

FIG. 4 illustrates a method that facilitates capture of recently-arrived text chunk of real-time post-appending body of on-screen text, in accordance with one or more implementations.

FIG. 5 is a block diagram illustrating an example system in accordance with the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Described herein is a technology that facilitates capture of recently-arrived text chunk of real-time post-appending body of on-screen text as disclosed. Exemplary implementations may: monitor a real-time post-appending body of on-screen text; obtain an end endpoint of the monitored body, which indicates a locus of the final character of existing on-screen text of the monitored body; remember the locus of the final character of existing on-screen text; adjust the end endpoint to an interior locus in the existing on-screen text of the monitored body; obtain a trigger that indicates that the monitored body may have been post-appended with new on-screen text; and in response to the trigger, chunk new on-screen text of the post-appended body based on a difference between the remembered locus and a new endpoint of the new on-screen text of the post-appended body.

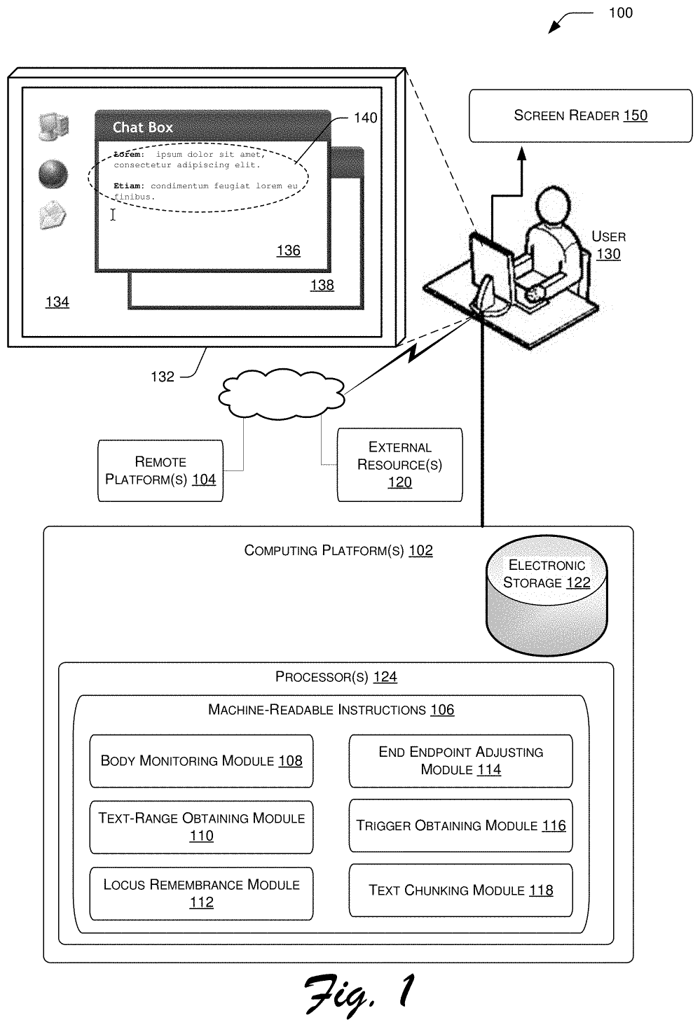

FIG. 1 illustrates an example system 100 configured to facilitate capture of recently-arrived text chunk of real-time post-appending body of on-screen text, in accordance with one or more implementations. As depicted, the system includes one or more computing platforms (102 and 104).

Computing platform(s) may be configured to communicate with one or more computing platforms (such as remote platform(s) 104) according to a client/server architecture and/or other architectures. Computing platform(s) may be configured to communicate with other computing platforms according to a peer-to-peer architecture and/or other architectures. Users, like user 130, may access system 100 via client computing platform(s) 102.

Computing platform(s) 102 may be configured by machine-readable instructions 106. Machine-readable instructions 106 may include one or more instruction modules. The instruction modules may include computer program modules. The instruction modules may include one or more of body monitoring module 108, text-range obtaining module 110, locus remembrance module 112, end endpoint adjusting module 114, trigger obtaining module 116, text chunking module 118, screen reader 150, and/or other instruction modules.

As depicted, the user 130 is interacting with the computer platform(s) 102 using a screen 134 of a display device 132 of the computer platform(s). On that screen are displayed two windows (136 and 138) that each represent an executing application operating on that computing platform(s) 102. Indeed, window 136 is active and is labeled “Chat Box,” which is the name of a fictitious chat application.

While a chat application is discussed herein for this example implementation, other applications may be involved with other implementations. For example, other implementations of the technology described herein may interact with applications with an active on-screen window in which a user types and receives a response, such as a command prompt.

A chat application (i.e., “app”) executes on a computer system (such as the computing platform(s) 102). So-called “chat” refers to the process of communicating, interacting and/or exchanging messages via a network or communication medium (i.e., the Internet). It involves a dialogue between two or more individuals that communicate through a chat-enabled service or application.

Window 136 includes a body 140 of on-screen text. The text inside window 136 (depicted in FIGS. 1, 2A, 2B, 3A, 3B, and 3C) is shown to represent a placeholder for textual content to demonstrate the visual form without relying on the meaningful content. Because the meaning of the textual content in windows 136 is not relevant herein, it is not important that the textual content of the windows 136 be legible. Indeed, the textual content is shown as so-called “Lorem ipsum,” Lorem ipsum is a placeholder text commonly used to demonstrate the visual form of a document without relying on meaningful content.

Since the text of the body 140 appears on the screen, it is called on-screen text herein. That body 140 of on-screen text represents a snapshot of the exchange of messages between the user 130 and one or more other individuals. The body 140 of the Chat Box window 136 is an example of a real-time post-appending body of on-screen text.

The text of a real-time post-appending body of on-screen text appears on the screen 134 as a series of text chunks that are appended to the end of the prior body of on-screen text. Since the newly entered or arrived text is attached after the final character of the prior body, it is called post-appending herein.

The appending process occurs as the chunks are entered or arrive. Thus, it is called “real-time” herein to describe the process in which the text chunks are appended.

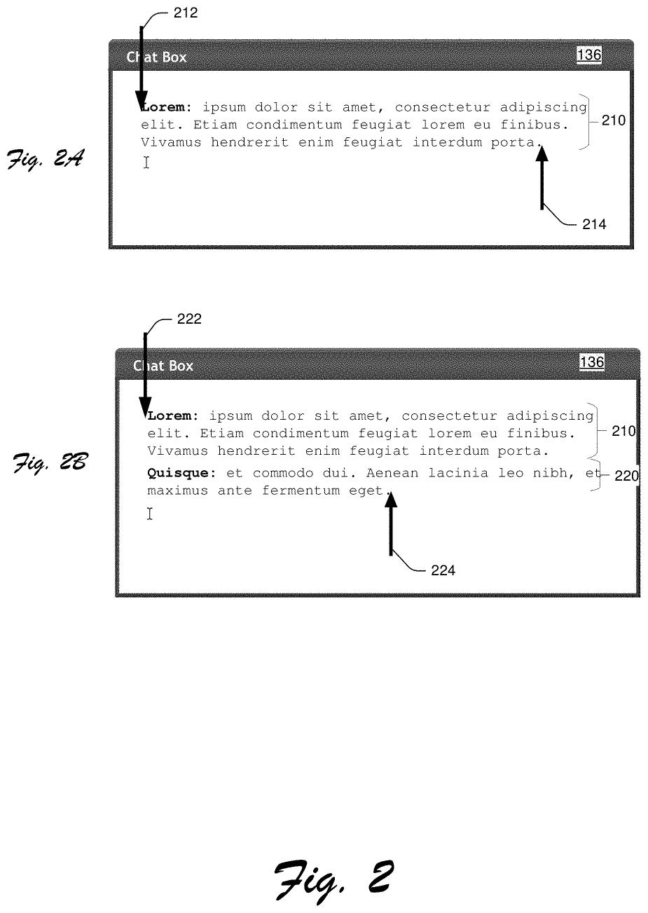

FIGS. 2A and 2B illustrate a portion of the relevant operation of the Chat Box window 136 and the technology described herein. FIG. 2A shows the initial set of text 210 in the Chat Box 136 window. For illustration purpose, presume this text was entered by the user 130 on the computing platform(s) 102.

The initial set of text 210 is the entirety of the text that is displayed on-screen in this window. As such, the initial set of text 210 is the present real-time post-appending body of on-screen text. In response to a request (e.g., to the operating system of the computing platform(s) 102) for the range of the text on-screen, a response may give start endpoint 212 and an end endpoint 214, which indicates the on-screen locations of the first and last characters, respectively, in the body of on-screen text.

A request like this is often answered by some form of assistive technology (AT). In particular, a so-called screen reader may respond to this type of request. Screen readers are applications or part of the operating system. Screen readers attempt to convey what people with normal eyesight see on a display to their users via non-visual means, for example, text-to-speech, sound icons, or a Braille device. Screen readers do this by applying a wide variety of techniques that include for example interacting with dedicated accessibility application programming interfaces (APIs), using various operating system features and employing hooking techniques. The MICROSOFT™ WINDOWS™ operating system offers a set of APIs called UI AUTOMATION to expose on-screen textual content.

With insider threat management, it is desirable to track the activities of users on the computing platforms. In this case of a chat application, it is difficult to track both insider user and the incoming exchanges. For example, a simple keystroke monitor will fail to capture the incoming messages.

Using assistive technologies (AT), insider threat management may be able to capture both the user's and incoming messages because both kinds appear on the screen. Thus, insider threat management using AT can capture the entire exchange a chunk at a time. Each chunk is a set of text representing an exchange between the user and others.

FIG. 2B illustrates that, unfortunately, with some AT there is an idiosyncrasy that limits and/or prevents identification of the newly arriving or latest chunk of text of a real-time post-appending body of on-screen text like that of a chat application. In FIG. 2B, additional text chunk 220 is appended after the initial set of text 210. For this example, the text block 220 is the message from another individual that was received via an incoming exchange. Collectively, set 210 and block 220 form the present real-time post-appending body of on-screen text.

In response to a request (e.g., to AT) for the range of the text on-screen, a response may give start endpoint 222 and an end endpoint 224, which indicate the on-screen locations of the first and last characters, respectively, in the body of on-screen text (which is a combination of set 210 and block 220). Unfortunately, this response fails to retain any historical information that allows us to parse the block 220 from the entirety of the existing body.

Returning again to the depiction of system 100 of FIG. 1, the body monitoring module 108 may be configured to monitor a real-time post-appending body of on-screen text. This monitoring may be facilitated, in part, by assistive technologies, as discussed above.

The real-time post-appending body of on-screen text may be produced by a messaging application (such as a chat application), he on-screen text being produced by an application executing on a computing system. The computing platform(s) 102 is an example of a computing system.

Text-range obtaining module 110 may be configured to obtain the range of the body of on-screen text monitored by the body monitoring module 108 (i.e., the “monitored body”). That is, the text-range obtaining module 110 obtains the screen location of the start of the body and the screen location of the end of the body. These are called the start endpoint and end endpoint, respectively. In some implementations, the module may only obtain the end endpoint. This text-range obtaining function may be facilitated, in part, by assistive technologies, as discussed above.

The end endpoint of the monitored body indicates an on-screen locus of the final character of the existing on-screen text of the monitored body. The monitored body may have a start endpoint and an end endpoint indicating the locus of a first and a final character, respectively, of the initial on-screen text of the monitored body. Arriving on-screen text appends after the final character of the initial on-screen text of the monitored body. The end endpoint may be updated to indicate the locus of a final character of the appended on-screen text.

Locus remembrance module 112 may be configured to remember the locus of the final character of existing on-screen text. That is, the locus remembrance module 112 stores a pointer to the location of the final character of the existing on-screen text.

As depicted in FIG. 2B, the locus remembrance module 112 stores a pointer to the location of the final character of the existing on-screen text. Herein, the stored pointer value is called the “remembered locus,” For the text depicted in FIG. 2B, the remembered locus would point to the location of the endpoint 224 (as returned by the text-range obtaining module 110).

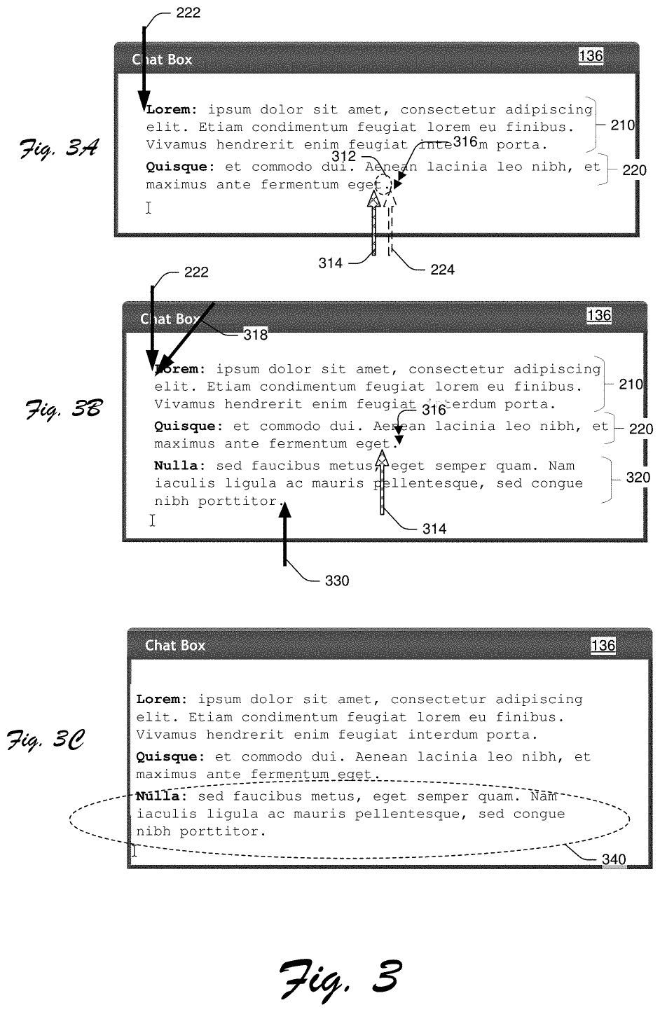

FIGS. 3A, 3B, and 3C illustrate a portion of an example relevant operation of the Chat Box window 136 and the technology described herein. FIG. 3A shows an existing monitored body of on-screen text composed of the initial set of text 210 and text block 220, collectively. Start endpoint 222 indicates the on-screen locus of the first character of the body.

As depicted in FIG. 3A, the locus remembrance module 112 stores the location of the end endpoint 224 into the remembered locus 316. Thus, the remembered locus 316 points to the on-screen location of the end endpoint 224.

End endpoint adjusting module 114 may be configured to adjust the end endpoint to an interior locus in the existing on-screen text of the monitored body. Interior locus is an on-screen location within the monitored body. That is, the interior locus is a spot on the screen between the start endpoint and the end endpoint returned by the text-range obtaining module 110.

As depicted in FIG. 3A, the end endpoint adjusting module 114 adjusts the value of the end endpoint to a spot that is two characters, for example, back from the original end endpoint 224 (as returned by the text-range obtaining module 110). The arrow representing the original or prior end endpoint 224 of the monitored body is shown in dashed lines because its value is being adjusted. The adjusted or temporary end endpoint 314 is shown as a hatched arrow to differentiate it from the nature of the other endpoints.

Characters “t.” inside dashed oval 312 are the two characters between the remembered locus 316 and the adjusted end endpoint 314. Two characters are used for this example to be near the original end endpoint but to avoid lost characters at the end of an exchange or line. However, other implementations may use some other location inside the existing monitored body.

FIG. 3B shows the same chat box window 136 of FIG. 3A with the addition of a new chunk 320 of on-screen text. This text chunk 320 may be entered by the user 130 or be part of an incoming message from another individual. In other implementations, this text chunk 320 may be a response from the operating system or another program.

Since the adjusted end endpoint 314 is no longer at the end of the previous body, when the value of the end endpoint is automatically incremented and advanced to the end of the new chunk 320, the adjusted end endpoint 314 stays the same value and points to location as indicated in FIG. 3B.

The actual end endpoint of all the on-screen text shown in chat box window 136 of FIG. 3B can be acquired by making a request for that. The text-chunking module 118 does exactly that in response to the trigger-obtaining module 116.

When the new chuck 320 is appended to the previous body, the computing platform(s) 102 may issue a computer event (e.g., interrupt, notification). The computer event may issue in response to, for example, particular keystrokes (e.g., entry key press) or when particular conditions arise. These may act as a trigger.

Trigger obtaining module 116 may be configured to obtain a trigger that indicates that the monitored body may have been post-appended with new on-screen text. The trigger may be a computer event. By way of non-limiting example, the trigger may be selected from a group consisting of a computer event, a keystroke event, and a timer.

A computer event may involve a polling mechanism that just checks periodically (e.g., every 2 seconds) to see if the endpoint has changed. If there is a difference, then trigger module 116. Another way is to utilize the events mechanism that an operating system provides. In that scenario, any time the text changes, an event is sent. The trigger obtaining module 116 may watch for particular events, and when they come in, that is a trigger.

In response to the trigger, the text-chunking module 118 may request a range of the present body of on-screen text. As depicted in FIG. 3B, the present body of on-screen text includes a combination of the initial set 210, the text block 220, and the text chunk 320. In response to the request, new endpoints are supplied (as facilitated by AT) to indicate the locations of the start and end endpoints of the present body of on-screen text.

Start endpoint 318 points to the location of the start endpoint of the present body. End endpoint 330 points to the location of the end endpoint of the present body. For this discussion, the end endpoint 330 may be called the “new” end endpoint since it is new relative to the previous body as shown in FIGS. 2B and 3A.

Indeed, as depicted in FIG. 3B, the start endpoint 222 points to the start of the previous body as shown in FIGS. 2B and 3A and the remembered locus 316 points to the location of the end of that same body.

Text chunking module 118 may be configured to, in response to the trigger, chunk new on-screen text of the post-appended body based on a difference between the remembered locus and a new endpoint of the new on-screen text of the post-appended body. Thus, the text-chunking module 118 produces an extracted text chunk 340 (as shown in FIG. 3C) after removing the text between start endpoint 318 and remembered locus 316 from the body of text in chat box window 136.

The chunking may include obtaining a new end endpoint (e.g., end endpoint 330) of the monitored body, which indicates the locus of the new final character of the post-appended on-screen text of the monitored body. The chunking may include extracting the text between the remembered locus and the new endpoint of the monitored body. The chunking may include providing the extracted text as a chunk of the monitored real-time post-appending body of on-screen text.

In some implementations, the textual display system (which may include display 132) may include the screen reader 150. The screen reader 150 may be its own module or part of another module of the computing platform(s) 102, part of the operating system, an application, and/or a service communicating with the computing platform(s) 102.

In some implementations, computer platform(s) 102, remote computing platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote computing platform(s) 104, and/or external resources 120 may be operatively linked via some other communication media.

A given remote computing platform 104 may include one or more processors configured to execute computer program modules. The computer program modules may be configured to enable an expert or user associated with the given remote computing platform 104 to interface with system 100 and/or external resources 120, and/or provide other functionality attributed herein to remote computing platform(s) 104. By way of non-limiting example, the given remote computing platform 104 may include one or more of a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

Computing platform(s) 102 may include electronic storage 122, one or more processors 124, and/or other components. Computing platform(s) 102 may include communication lines, or ports to enable the exchange of information with a network and/or other computing platforms. Illustration of Computing platform(s) 102 in FIG. 1 is not intended to be limiting. Computing platform(s) 102 may include a plurality of hardware, software, and/or firmware components operating together to provide the functionality attributed herein to Computing platform(s) 102. For example, Computing platform(s) 102 may be implemented by a cloud of computing platforms operating together as Computing platform(s) 102.

Electronic storage 122 may comprise non-transitory storage media that electronically stores information. The electronic storage media of electronic storage 122 may include one or both of system storage that is provided integrally (i.e., substantially non-removable) with Computing platform(s) 102 and/or removable storage that is removably connectable to Computing platform(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables computing platform(s) 102 to function as described herein.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute modules 108, 110, 112, 114, 116, and/or 118, and/or other modules. Processor(s) 124 may be configured to execute modules 108, 110, 112, 114, 116, and/or 118, and/or other modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, and/or 118 are illustrated in FIG. 1 as being implemented within a single processing unit, in implementations in which processor(s) 124 includes multiple processing units, one or more of modules 108, 110, 112, 114, 116, and/or 118 may be implemented remotely from the other modules. The description of the functionality provided by the different modules 108, 110, 112, 114, 116, and/or 118 described below is for illustrative purposes, and is not intended to be limiting, as any of modules 108, 110, 112, 114, 116, and/or 118 may provide more or less functionality than is described. For example, one or more of modules 108, 110, 112, 114, 116, and/or 118 may be eliminated, and some or all of its functionality may be provided by other ones of modules 108, 110, 112, 114, 116, and/or 118. As another example, processor(s) 124 may be configured to execute one or more additional modules that may perform some or all of the functionality attributed below to one of modules 108, 110, 112, 114, 116, and/or 118.

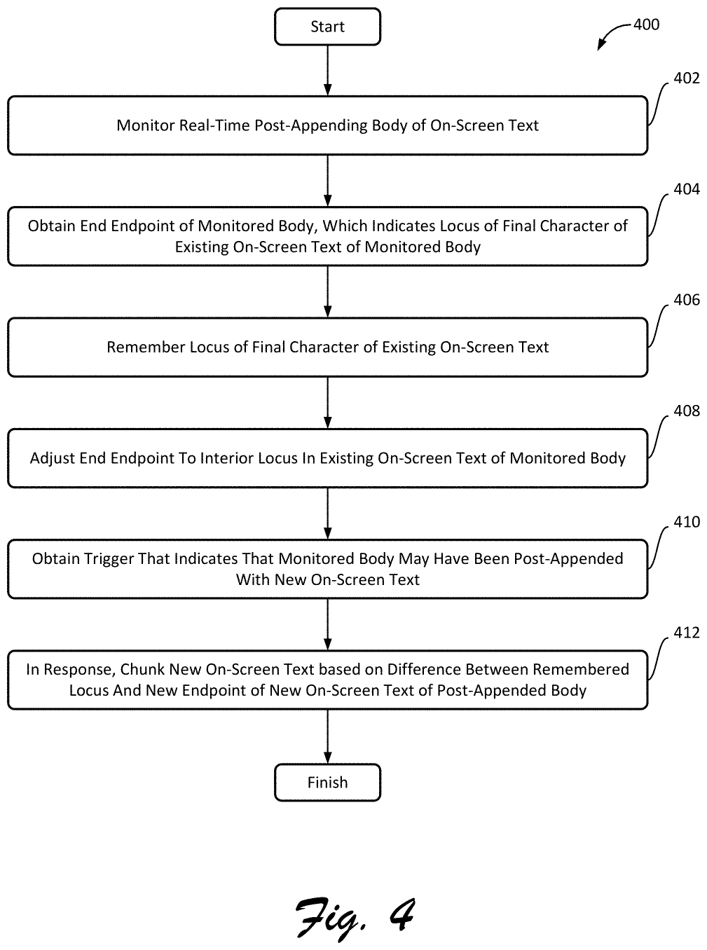

FIG. 4 illustrates a method 400 that facilitates capture of recently-arrived text chunk of real-time post-appending body of on-screen text, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include monitoring a real-time post-appending body of on-screen text, the on-screen text being produced by an application executing on a computing system. Operation 402 may be performed by one or more hardware processors configured by machine-readable instructions including a module that is the same as or similar to body monitoring module 108, in accordance with one or more implementations.

An operation 404 may include obtaining an end endpoint of the monitored body, which indicates a locus of the final character of the existing on-screen text of the monitored body. Operation 404 may be performed by one or more hardware processors configured by machine-readable instructions including a module that is the same as or similar to text-range obtaining module 110, in accordance with one or more implementations.

An operation 406 may include remembering the locus of the final character of existing on-screen text. Operation 406 may be performed by one or more hardware processors configured by machine-readable instructions including a module that is the same as or similar to locus remembrance module 112, in accordance with one or more implementations.

An operation 408 may include adjusting the end endpoint to an interior locus in the existing on-screen text of the monitored body. Operation 408 may be performed by one or more hardware processors configured by machine-readable instructions including a module that is the same as or similar to end endpoint adjusting module 114, in accordance with one or more implementations.

An operation 410 may include obtaining a trigger that indicates that the monitored body may have been post-appended with new on-screen text. Operation 410 may be performed by one or more hardware processors configured by machine-readable instructions including a module that is the same as or similar to trigger obtaining module 116, in accordance with one or more implementations.

An operation 412 may include in response to the trigger, chunking new on-screen text of the post-appended body based on a difference between the remembered locus and a new endpoint of the new on-screen text of the post-appended body. Operation 412 may be performed by one or more hardware processors configured by machine-readable instructions including a module that is the same as or similar to text chunking module 118, in accordance with one or more implementations.

Example Information Handling System

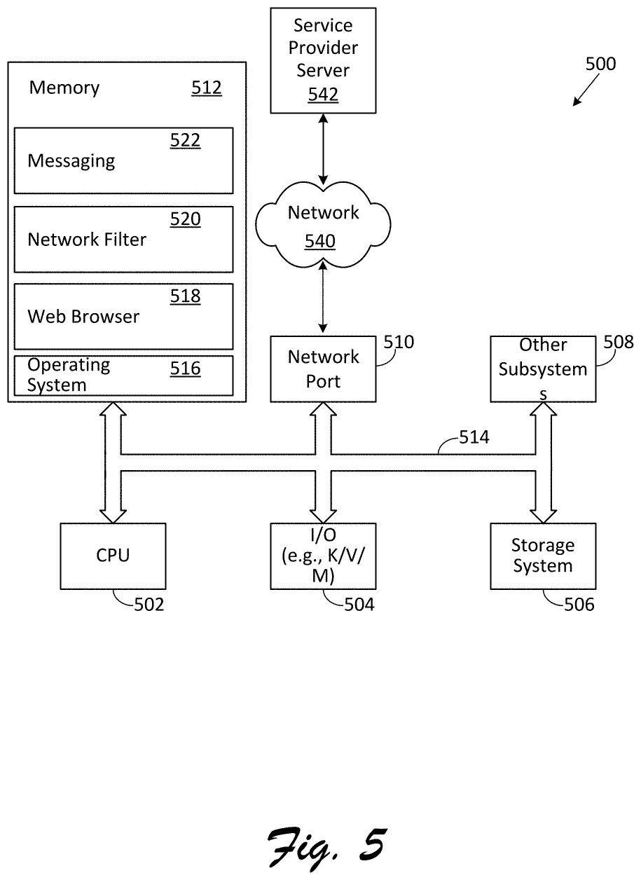

FIG. 5 is a generalized illustration of an information handling system 500 that can be used to implement the technology described herein. The information handling system 500 includes one or more processors (e.g., central processor unit or “CPU”) 502, input/output (I/O) devices 504, such as a display, a keyboard, a mouse, and associated controllers, a storage system 506, and various other subsystems 508. In various embodiments, the information handling system 500 also includes network port 510 operable to connect to a network 540, which is likewise accessible by a service provider server 542.

The information handling system 500 likewise includes system memory 512, which is interconnected to the foregoing via one or more buses 514. System memory 512 further includes an operating system (OS) 516 and in various embodiments may also include a web browser 518, network filter 520, and a messaging application 522. In one embodiment, the information handling system 500 is able to download the web browser 518, the network filter 520, and/or the messaging application 522 from the service provider server 542. In another embodiment, the web browser 518, the network filter 520, and/or the messaging application 522 are provided as a service from the service provider server 542.

In various embodiments, in combination, alone, or with cooperation with the service provider 542 and/or the network 540, the web browser 518, the network filter 520, and/or the messaging application 522 perform the operations of the technology described herein. As will be appreciated, once the information handling system 500 is configured to perform the detection of potentially deceptive URI of a homograph attack, as described herein, the information handling system 500 becomes a specialized computing device specifically configured to perform such detection operations and is not a general purpose computing device. Moreover, the implementation of the web browser 518, the network filter 520, and/or the messaging application 522 on the information handling system 500 improves the functionality of the information handling system 500 and provides a useful and concrete result of detection of malicious attacks.

### ADDITIONAL AND ALTERNATIVE IMPLEMENTATION NOTES

In the above description of example implementations, for purposes of explanation, specific numbers, materials configurations, and other details are set forth in order to better explain the present disclosure. However, it will be apparent to one skilled in the art that the subject matter of the claims may be practiced using different details than the example ones described herein. In other instances, well-known features are omitted or simplified to clarify the description of the example implementations.

The terms “techniques” or “technologies” may refer to one or more devices, apparatuses, systems, methods, articles of manufacture, and/or executable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that may be implemented in mechanics alone, with hardware, and/or with hardware in combination with firmware or software. In the context of software/firmware, the blocks represent instructions stored on one or more non-transitory computer-readable storage media that, when executed by one or more processors or controllers, perform the recited operations.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

The term “computer-readable media” is non-transitory computer-storage media or non-transitory computer-readable storage media. For example, computer-storage media or computer-readable storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

1. A system configured to facilitate capture of recently-arrived text chunk of real-time post-appending body of on-screen text, the system comprising:
one or more hardware processors configured by machine-readable instructions to:
monitor a real-time post-appending body of on-screen text, wherein the on-screen text is produced by an application executing on a computing system;
obtain an end endpoint of the monitored body, which indicates a locus of the final character of existing on-screen text of the monitored body;
remember the locus of the final character of existing on-screen text;
adjust the end endpoint to an interior locus in the existing on-screen text of the monitored body;
obtain a trigger that indicates that the monitored body may have been post-appended with new on-screen text; and
in response to the trigger, chunk new on-screen text of the post-appended body based on a difference between the remembered locus and a new endpoint of the new on-screen text of the post-appended body.

2. The system of claim 1, wherein the chunking includes obtaining a new end endpoint of the monitored body, which indicates the locus of the new final character of post-appended on-screen text of the monitored body;
wherein the chunking includes extracting the text between the remembered locus and the new endpoint of the monitored body;
wherein the chunking includes providing the extracted text as a chunk of the monitored real-time post-appending body of on-screen text.

3. The system of claim 1, wherein the monitored body has a start endpoint and an end endpoint indicating the locus of a first and a final character, respectively, of initial on-screen text of the monitored body, arriving on-screen text appends after the final character of initial on-screen text of the monitored body, and the end endpoint is updated to indicate the locus of a final character of the appended on-screen text.

4. The system of claim 1 further comprising a screen reader.

5. The system of claim 1, wherein the real-time post-appending body of on-screen text is produced by a messaging application.

6. The system of claim 1, wherein the trigger is computer event.

7. The system of claim 1, wherein the trigger is selected from a group consisting of a computer event, a keystroke event, and a timer.

8. A method that facilitates capture of recently-arrived text chunk of real-time post-appending body of on-screen text, the method comprising:
monitoring a real-time post-appending body of on-screen text, wherein the on-screen text being produced by an application executing on a computing system;
obtaining an end endpoint of the monitored body, which indicates a locus of the final character of existing on-screen text of the monitored body;
remembering the locus of the final character of existing on-screen text;
adjusting the end endpoint to an interior locus in the existing on-screen text of the monitored body;
obtaining a trigger that indicates that the monitored body may have been post-appended with new on-screen text; and
in response to the trigger, chunking new on-screen text of the post-appended body based on a difference between the remembered locus and a new endpoint of the new on-screen text of the post-appended body.

9. The method of claim 8, wherein the chunking includes obtaining a new end endpoint of the monitored body, which indicates the locus of the new final character of post-appended on-screen text of the monitored body;
wherein the chunking includes extracting the text between the remembered locus and the new endpoint of the monitored body;
wherein the chunking includes providing the extracted text as a chunk of the monitored real-time post-appending body of on-screen text.

10. The method of claim 8, wherein the monitored body has a start endpoint and an end endpoint indicating the locus of a first and a final character, respectively, of initial on-screen text of the monitored body, arriving on-screen text appends after the final character of initial on-screen text of the monitored body, and the end endpoint is updated to indicate the locus of a final character of the appended on-screen text.

11. The method of claim 8 further comprising responding to a request for a range of the on-screen text.

12. The method of claim 8, wherein the real-time post-appending body of on-screen text is produced by a messaging application.

13. The method of claim 8, wherein the trigger is computer event.

14. The method of claim 8, wherein the trigger is selected from a group consisting of a computer event, a keystroke event, and a timer.

15. A non-transient computer-readable storage medium having instructions embodied thereon, the instructions being executable by one or more processors to perform a method that facilitates capture of recently-arrived text chunk of real-time post-appending body of on-screen text, the method comprising:
monitoring a real-time post-appending body of on-screen text, wherein the on-screen text being produced by an application executing on a computing system;
obtaining an end endpoint of the monitored body, which indicates a locus of the final character of existing on-screen text of the monitored body;
remembering the locus of the final character of existing on-screen text;
adjusting the end endpoint to an interior locus in the existing on-screen text of the monitored body;
obtaining a trigger that indicates that the monitored body may have been post-appended with new on-screen text; and
in response to the trigger, chunking new on-screen text of the post-appended body based on a difference between the remembered locus and a new endpoint of the new on-screen text of the post-appended body.

16. The computer-readable storage medium of claim 15, wherein the chunking includes obtaining a new end endpoint of the monitored body, which indicates the locus of the new final character of post-appended on-screen text of the monitored body;
wherein the chunking includes extracting the text between the remembered locus and the new endpoint of the monitored body;
wherein the chunking includes providing the extracted text as a chunk of the monitored real-time post-appending body of on-screen text.

17. The computer-readable storage medium of claim 15, wherein the monitored body has a start endpoint and an end endpoint indicating the locus of a first and a final character, respectively, of initial on-screen text of the monitored body, arriving on-screen text appends after the final character of initial on-screen text of the monitored body, and the end endpoint is updated to indicate the locus of a final character of the appended on-screen text.

18. The computer-readable storage medium of claim 15 further comprising responding to a request for a range of the on-screen text.

19. The computer-readable storage medium of claim 15, wherein the real-time post-appending body of on-screen text is produced by a messaging application.

20. The computer-readable storage medium of claim 15, wherein the trigger is computer event.
